(19) United States
(12) Patent Application Publication
(10) Pub. No.: US 2012/0112731 A1
(43) Pub. Date: May 10, 2012

(54) LOAD SENSING HIGH EFFICIENCY TRANSFORMER ASSEMBLY

(75) Inventor: Derek Foster, Johnsburg, IL (US)

(73) Assignee: Warner Power, LLC, Warner, NH (US)

(21) Appl. No.: 13/296,542

(22) Filed: Nov. 15, 2011

Related U.S. Application Data
(63) Continuation-in-part of application No. 12/791,419, filed on Jun. 1, 2010.
(60) Provisional application No. 61/183,326, filed on Jun. 2, 2009.

(51) Int. Cl. H01F 30/12

(52) U.S. Cl. 323/361

(57) ABSTRACT

A load sensing, high efficiency, modular transformer assembly for use in power distribution networks. The control of each module of the modular assembly of high efficiency transformers results in considerable energy savings when compared to conventional transformers. At least two of the transformers have different efficiencies, one higher than the other, The assembly is controlled according to the requirements of the connected load, with modules being switched in and out of circuit, thereby resulting in a transformer with a higher efficiency than is possible with currently available distribution transformers of equivalent capacity. Connection and disconnection of the transformer modules is accomplished with the use of a purpose designed electronic controller.

### CROSS-REFERENCE TO RELATED APPLICATIONS

This application is a continuation-in-part and therefore claims priority to U.S. patent application Ser. No. 12/791,419 filed on Jun. 1, 2010 titled “Load Sensing High Efficiency Transformer Assembly” and Provisional Patent Application Nos. 61/183,326 filed on Jun. 2, 2009 entitled “Load Sensing High Efficiency Transformer” which are incorporated fully herein by reference.

### FIELD OF THE INVENTION

This invention relates generally to electrical transformers for use in power distribution networks and specifically, to the control of a modular assembly of high efficiency transformers, which results in considerable energy savings when compared to conventional transformers.

### BACKGROUND

An electrical transformer is an electromagnetic device that transfers electrical energy from one circuit to another through mutual inductance. During this energy transfer, electricity may be converted from one voltage level or type to another. The transformer comprises two windings, the primary winding connected to the source of voltage and the secondary winding connected to the load. The windings are wound around a silicon steel laminated core which provides a path for the flow of magnetic flux to achieve the transfer of energy from the primary to the secondary winding. Transformers are identified by their capacity, i.e. the amount of power they can handle, in kiloVoltAmps, or kVA.

Normal transformer operation results in energy losses in the form of heat. The higher the losses in a given transformer, the lower the efficiency of the transformer. The energy losses comprise two component parts, the core losses and the winding losses. Core losses are generated whenever voltage is applied to the primary winding of the transformer and are constant for a constant applied voltage, irrespective of the load current being drawn from the secondary winding.

Transformer windings are generally designed to carry 100% of the rated load current continuously, without exceeding the design temperature rise of the transformer. Therefore, at any load current less than 100% of the rated load current, the capacity of a transformer winding is not being fully utilized.

Surveys have shown that transformer loading is rarely even close to 100% of rated capacity. For distribution transformers, a design load of 35% is typical. In many cases, the actual loading may be from 15% to 25%. For example, if a transformer of 75 kVA capacity is installed but only 35% of this capacity is being used, i.e. 26.25 kVA, then a transformer of 26.25 kVA capacity could have been installed instead. The disadvantage of using the smaller transformer is that no overload capacity is available and no capacity is available for any future load additions.

The advantage of using the smaller transformer is that the power losses, and in particular, the losses in the silicon steel core of the transformer, are much less than those of a larger transformer, with a resulting saving in cost to the end user, and less load on the utility distribution system. The losses in the core of the transformer are proportional to the physical size of the core, while the losses in the windings are proportional to the square of the load current being drawn and proportional to the electrical resistance of the transformers windings.

As a result, what is needed is a load sensing high efficiency transformer system and assembly that overcomes the disadvantages of using a larger transformer by being constructed in “modular” form. The number of transformer “modules” in use at any time could therefore be dependent upon the load current being drawn. As the load current varies, the number of transformer “modules” in use should also vary, with the transformer “modules” being automatically switched in and out of circuit as required and as sensed and controlled by an appropriate control circuit.

### SUMMARY

The present invention features a load sensing, high efficiency, modular transformer assembly for use in power distribution networks. The control of each “module” of the modular assembly of high efficiency transformers results in considerable energy savings when compared to conventional transformers. The assembly is controlled according to the requirements of the connected load, with modules being switched in and out of circuit, thereby resulting in a transformer with a higher efficiency than is possible with currently available distribution transformers of equivalent capacity. Connection and disconnection of the transformer modules is accomplished with the use of a purpose designed electronic controller.

In one embodiment, the present invention features a multi-module transformer assembly comprising a plurality of transformer modules, each transformer module having at least one input and at least one output, wherein one of the plurality of transformer modules is continuously connected to an input source and to an output load, and wherein at least one input of each of the remaining of the plurality of transformer modules is connected to the input source by means of a control relay. The control relay responsive to a predetermined transformer module control signal, each predetermined transformer module control signal configured for energizing and de-energizing a corresponding one of the plurality of transformer modules.

A controller is coupled to the output of each of the plurality of transformer modules, and configured for sensing the output current of the plurality of transformer modules being drawn by a load coupled to the plurality of transformer module outputs, for determining whether the output current of the plurality of transformer modules is equal to greater than one of the transformer modules set point or greater than two or more of the transformer module set point, and responsive to the determination, for providing one or more of a transformer module control signal for energizing one or more of the plurality of transformer modules in response to the output current of the transformer modules being drawn by a load.

In another embodiment, the controller is further configured to provide, on a rotating basis, each of the transformer module control signals for each of the plurality of transformer modules, such that when one or more transformer modules are deactivated, the controller rotates through the activation and deactivation of each of the plurality of transformer modules (or at least each module minus one that is always connected in the circuit) thereby ensuring that all of the plurality of transformer modules are in generally regular use.

In yet another embodiment, the present invention features a three module transformer assembly comprising a first transformer module having at least one input and at least one output, wherein the at least one input of the first transformer module is connected to an input; a second transformer module having at least one input and at least one output, wherein the at least one input of the second transformer module is connected to an input source by means of a control relay, and wherein the control relay is responsive to a second transformer module control signal, for energizing and de-energizing the second transformer module; and further including a third transformer module having at least one input and at least one output, wherein the at least one input of the third transformer module is connected to an input source by means of a control relay, the control relay being responsive to a third transformer module control signal, for energizing and be energized and the third transformer module.

The invention also features a controller, coupled to the output of the first, second and third transformer modules and to the second and third transformer module control relay, and configured for sensing the output current of the transformer modules being drawn by a load coupled to the first, second and third transformer module outputs, for determining whether the output current of all of the transformer modules is equal to greater than one of the transformer modules or greater than two of the transformer modules, and responsive to that determination, for providing one or more of a second and third transformer module control signal for energizing one or more of the second and third transformer modules in response to the output current of the transformer modules being drawn by a load.

In another embodiment, the controller is configured such that when the controller senses that the output current of the transformer modules being drawn by a load is less than a first pre-established percentage of the total output load capacity of the transformer assembly, the controller causes the transformer module control signal for the third transformer module to open, thereby deactivating the third transformer module. In this embodiment, the first pre-established percentage may be ⅔ of the total output load capacity of the transformer assembly.

The controller may be further configured such that when the controller senses that the output current of the transformer modules being drawn by a load is less than a second pre-established percentage of the total output load capacity of the transformer assembly, the controller causes the transformer module control signal for the second and third transformer modules to open, thereby deactivating the second and third transformer modules. The second pre-established percentage may be ⅓ of a total output load capacity of the transformer assembly.

The controller may also be configured such that when the controller senses that the output current of the transformer modules being drawn by a load is greater than the first pre-established percentage of the total output load capacity of the transformer assembly, the controller causes the transformer module control signal for the third transformer module to close, thereby activating the first, second and third transformer modules. The controller may further be configured to provide, on a rotating basis, the second and third transformer module control signals, such that when one or more modules are deactivated, the controller rotates through the activation and deactivation of the second and third transformer modules thereby ensuring that all modules are in regular use.

Each transformer module of the transformer assembly may include a three-phase core with linear core leg configuration that employs cut strip laminations of silicon steel in a butt lap or mitered pattern. Alternatively, each transformer module may include a hexacore three-phase core with triangular core leg configuration that employs continuously wound loops of silicon steel. In another alternative, each transformer module of the transformer assembly may include a distributed gap core with three-phase linear core leg configuration that employs cut and formed strips of silicon steel that are interleaved to provide staggered joints within the core legs. Each transformer module of the transformer assembly may alternatively include an amorphous core with three-phase linear core leg configuration that employs cut and formed strips of amorphous steel or a hexacore three-phase core with triangular core leg configuration that employs continuously wound loops of amorphous steel.

In another embodiment, the invention may feature a multi-module transformer assembly as generally described above however wherein each of the plurality of transformer modules features an energy efficiency rating, at least one of the plurality of transformers including a first energy efficiency rating that is higher than a second energy efficiency rating of at least a second transformer. A controller, coupled to said output of each of said plurality of transformer modules, is configured for energizing the transformer modules in the order of their energy efficiency rating from highest to lowest.

### BRIEF DESCRIPTION OF THE DRAWINGS

These and other features and advantages of the present invention will be better understood by reading the following detailed description, taken together with the drawings wherein:

FIG. 1 is a plan drawing of a conventional transformer with one core/coil assembly;

FIG. 2 is a plan drawing of a load sensing high efficiency transformer with three core/coil assemblies according to the present invention; and

FIG. 3 is a schematic diagram of one embodiment of a load sensing high efficiency transformer of the present invention.

### DETAILED DESCRIPTION OF THE PREFERRED EMBODIMENTS

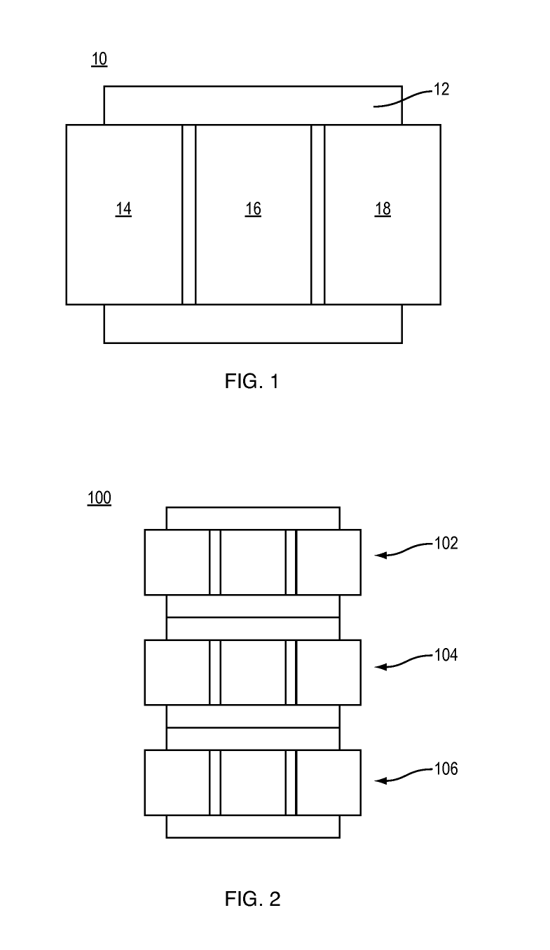

A standard, prior art, three-phase electrical distribution transformer 10, as shown in FIG. 1, typically used to take 480 VAC input down to 120/208 VAC for use within buildings comprises a single laminated silicon steel core 12, onto which three coils 14, 16 and 18 are wound. Each coil has a primary winding and a secondary winding. Such transformers are typically dry type transformers mounted in ventilated enclosures, typically inside a building such as in a basement or switch room. This single transformer assembly is designed to handle the full rated kVA capacity required. Since the transformer core is a single piece, the total losses in the core will be generated whenever the primary winding is energized from the power source, irrespective of the load current being drawn. Once manufactured, there is no way to reduce the value of the core losses in such a transformer. For example, if the transformer is manufactured to have a 75 kVA capacity, the transformer will continually operate with core losses equivalent to the full 75 kVA capacity regardless of the load placed on the transformer. The result is continual energy loss even when the load is less than 100% of the transformer's capacity.

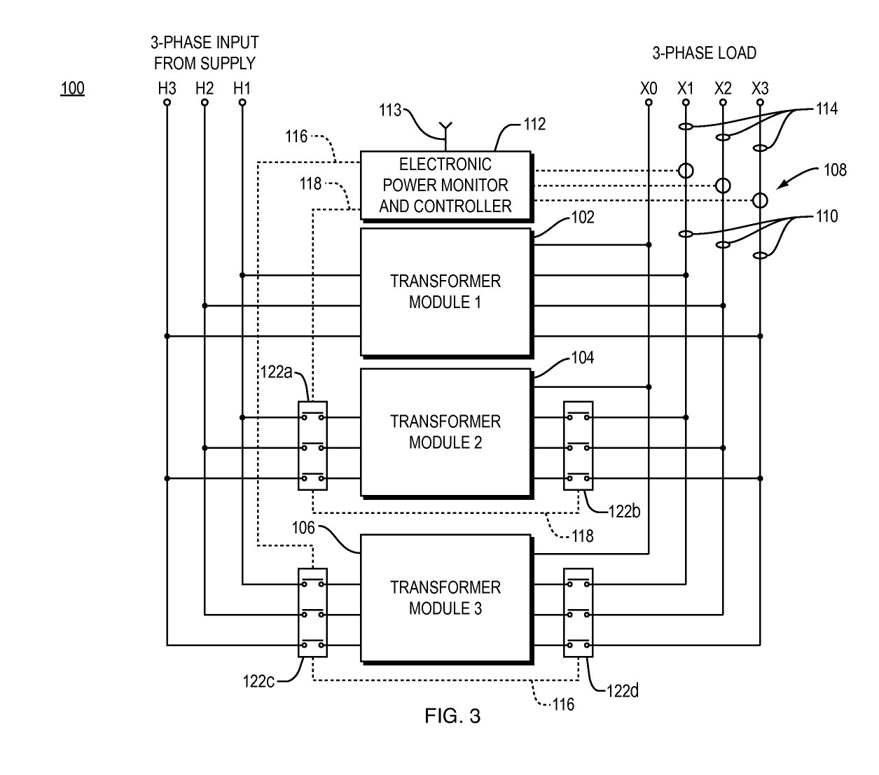

In one embodiment of the present invention, as shown in FIGS. 2 and 3, the load sensing, high efficiency, modular transformer assembly 100 is constructed using three transformer modules 102, 104, 106. Each transformer “module” is in fact a single complete transformer core and coil assembly, employing typically copper windings, but not limited to copper, yet, in one embodiment, rated for only one third (in the case of 3 transformer modules—if there were four modules, each could be rated for one quarter of the required capacity in the first embodiment) of the total required capacity of the entire transformer assembly. In the following description, the transformer modules are referred to as module 1 (102), module 2 (104) and module 3 (106).

The load current measured at the load output 114, FIG. 3, being drawn from the first embodiment of the present invention is continuously monitored by current sensors 108, which are located on output terminals 110 of the transformer assembly 100. The output of the current sensor 108 is a voltage that is proportional to the load current 114 being drawn. This voltage level is then passed to the controller 112. The controller 112 and built in electronic power monitor will feature data entry capability 113 for facilitating the input of programming control and sensor algorithms.

The purpose designed electronic controller 112 is programmed with two set points, whose values usually coincide with the maximum rated output of one transformer module and two transformer modules respectively, i.e. at 33% and 66% of the total rated capacity of the transformer assembly 100. But these set points are adjustable during manufacture, so may be set at other values where appropriate. When initially energized, transformer module 1 (102) is directly connected to the load, while transformer module 2 (104) and transformer module 3 (106) are connected to the load through control relays 122, one on each phase of the input and output of transformer module 2 (104) and transformer module 3 (106) such that the load current capacity of the entire transformer assembly 100 is equivalent to its total rated capacity.

The current sensor 108 will immediately begin monitoring the load current 114 and if the controller 112 senses that the load current 114 is greater than the load current capacity of two transformer modules, the controller will take no action, and all three transformer modules 102, 104 and 106 will remain connected to the load. If, however, the sensed load current is less than the maximum current capacity of two transformer modules, the controller causes the control relay contacts 122c and 122d for module 3 (106) to open, disconnecting module 3 (106) from the circuit, leaving only module 1 (102) and module 2 (104) in the circuit and operational. By eliminating module 3 (106) from the circuit, the core losses of the transformer assembly 100 are then reduced to two thirds of the total value of core losses. If at any time the sensed load current 114 is less than the maximum current capacity of one transformer module, the controller 112 causes the control relay contacts 122a and 122b for module 2 (104) to open (in addition to previously having disconnected module 3 (106), disconnecting module 2 (104) from the circuit, leaving only module 1 (102) in circuit. The core losses of the transformer (100) are then reduced to one third of the total value of core losses.

Since each transformer module is rated for one third of the total capacity of the complete transformer assembly, the core losses will be significantly reduced when only one or even two transformer modules are connected. Typical applications for such a transformer would be within an office building, schools or stores. During the daytime hours, the transformer may be fully loaded, with all three-transformer modules connected. However, during the night hours, when there is no or a reduced load current, or a very small load current being drawn from the transformer, the transformer has the ability to disconnect one or more modules. Therefore, there will be a saving in core losses of up to two thirds of the total core losses.

When the sensed load current remains less than the maximum current capacity of one transformer module, the controller 112 takes no further action. When the sensed load current exceeds the maximum current capacity of one transformer module, the controller sends a signal to the control switching relays 122a and 122b for the second module 104, whose contacts then close, to energize module 2 (104). With two transformer modules 102, 104 now in circuit, the load current capacity of the unit is two thirds that of its total capacity. The two transformer modules then operate in parallel until a further change in sensed load current occurs. If the sensed load current exceeds the maximum current capacity of two transformer modules, the controller sends a signal to the control switching relays 122c and 122d for module 3, whose contacts then close, to energize module 3 (106). With three transformer modules now in circuit, the current capacity of the unit is equivalent to its total capacity. The three transformer modules then operate in parallel until a further change in sensed load current occurs. The controller 112 controls modules by means of control relay signals 116 (for module 3), and 118 (for module 2).

Although the present invention has been described above in accordance with one embodiment utilizing three transformer modules, one of ordinary skill in the art will recognize that this is not a limitation of the present invention as other transformer assembly configurations are possible. For example, a transformer assembly 100 may include 4 transformer modules, each of which is rated for 25% of the total transformer output. Similarly, it is contemplated that a transformer assembly 100 may include 5 transformer modules, each of which is rated for 20% of the total transformer output.

In another embodiment, it is contemplated that a transformer assembly 100 may include transformer modules which may or may not be of identical rating but which may have different “set points”, that is, the pre-established trigger at which a second transformer module is switched in or switched out of use in the transformer assembly.

The set point number or rating (i.e. set points) at which the various transformer modules are connected and disconnected from the circuit will normally correspond to the number of modules minus one. However, the number of set points and the value of the set points are variable. For example, for a three module transformer assembly, in place of having the set points correspond to the value of each module (i.e. 33% and 66%) the first set point may be set at 20% and the second at 35%. As such, more control over transformer load outputs and transformer losses may be provided utilizing the idea and system and method behind the present invention.

Many applications for the modular transformer assembly of the present invention will operate continuously at loads less than the total rated current capacity of the unit. For example, the load current may never exceed two thirds of the total rated current capacity of the unit, resulting in transformer module 3 (106) never being energized. This could be detrimental to the transformer module that is rarely or never utilized, due to moisture ingress, resulting in degradation of the electrical insulation system of the transformer coils, causing premature failure of the transformer module, if at some time it is required to be energized. Therefore, the electronic controller (112) incorporates a function which utilizes transformer module (104) and transformer module 3 (106) in rotation. The modules are rotated automatically at regular intervals, with no effect on the load current. The rotation is performed by the controller (112). For example, if module 1 (102) and module 2 (104) are in use at the time when rotation is to occur, then the controller (112) causes module 3 (106) to be energized and then causes module 2 (104) to be de-energized, leaving module 1 (102) and module 3 (106) in use. At the next rotation time, the controller causes module 2 (104) to be energized and then causes module 3 (106) to be de-energized, leaving module 1 (102) and module 2 (104) in use.

The controller (112) continues indefinitely to rotate the modules in this way, irrespective of the number of modules in use, thereby making sure that all modules are in regular use. The rotation time may be controlled by a variety of factors including the location of installation, weather, temperature, humidity or other factors.

The electronic controller 112 may incorporate a self diagnosis capability, whereby, in the event of a malfunction within the electronic controller 112 which results in the loss of the control functions, the control relays on the input side of transformer module 2 (104) 122a and transformer module 3 (106) 122c will close, permitting the availability of the full rated capacity of the transformer 100. The electronic controller 112 by virtue of its continuous load monitoring function can arrange to provide data input to a communication infrastructure for Smartgrid applications.

By continuously monitoring the total load current being drawn from the transformer 100, the controller 112 allows the transformer modules 104, 106 to be energized and de-energized as required according to the load requirements and current capacity of the transformer modules. In a conventional transformer (10), the core losses are constant, irrespective of the load current being drawn. In the present invention, the core losses are reduced at lower values of load, leading to considerable energy savings and therefore cost savings.

Table 1 below shows a comparison between the losses of the most widely used and lowest cost type of transformer, i.e. aluminum wound with a 150° C. temperature rise, and the invention, as disclosed herein. As shown in table 1, when the total ownership cost of a transformer is calculated, the additional up-front cost savings when using the invention is recovered in a short period of time due to the energy savings that are realized when the core losses are reduced.

TABLE 1

| | | | | | Standard Aluminum | | |
|---|---|---|---|---|---|---|---|
| | | Present Invention | | | Wound Transformer | | |
| | | | Wind- | | | Wind- | |
| % full | | Core | ing | Total | Core | ing | Total |
| load | kVA | Losses | Losses | Losses | Losses | Losses | Losses |
| 25 | 18.75 | 100 | 182 | 282 | 375 | 177 | 552 |
| 35 | 26.25 | 100 | 356 | 456 | 375 | 347 | 722 |
| 45 | 33.75 | 200 | 294 | 494 | 375 | 573 | 948 |
| 55 | 41.25 | 200 | 440 | 640 | 375 | 856 | 1231 |
| 65 | 48.75 | 200 | 614 | 814 | 375 | 1195 | 1570 |
| 70 | 52.50 | 200 | 712 | 912 | 375 | 1386 | 1761 |
| 85 | 63.75 | 300 | 700 | 1000 | 375 | 2044 | 2419 |
| 95 | 71.25 | 300 | 874 | 1174 | 375 | 2553 | 2928 |
| 100 | 75.00 | 300 | 969 | 1269 | 375 | 2829 | 3204 |

In a further embodiment of the present invention, it is contemplated that the three transformers (102, 104 and 106) may not be identical, but rather, may be of three different efficiency levels. For example, in this embodiment the base load transformer module 1 (102) (the transformer that is on essentially all or most of the time) is configured to be the most efficient of the three transformers. Transformer 1, with the greatest efficiency, will also feature the highest cost. Transformer module 2 (104) is selected and configured to be somewhat less energy efficient than transformer module 1 (102) and therefore a lower cost than module 1 (102). Since transformer module 2 (104) does not operate as frequently as transformer module 1 (102), the user can live with slightly less efficiency which is offset to some degree by the lower cost of the transformer.

Module 3 (106) is selected and configured to be somewhat less energy efficient than transformer module 2 (104) and is therefore a lower cost than module 2 (104). In this embodiment, the cost savings derived from the use of a higher-cost energy efficient transformer module are realized by utilizing the most energy efficient module in the transformer module 1 (102). Savings can be further realized by using the least efficient and therefore highest operating cost module (but least expensive purchase cost) in transformer module 3 (106). Since module 3 is the least used module, using a less efficient transformer is cost efficient, especially given the lower cost of the transformer.

In this embodiment, the rotation feature previously discussed may not be used, or alternatively, may be used on a very limited basis. It is contemplated and within the scope of the current invention that this embodiment can also be used with greater or fewer than three modules. Additionally, it is not necessary that all three modules have varying efficiency ratings. For example, module 1 and 2 could both be highly energy efficient, while only module 3 is less energy efficient. In another example, module 1 could be highly energy efficient and module 2 and 3 could both be the same type of lower efficiency.

A variety of core configurations may be used for the transformers. In a first example, a conventional three-phase core with linear core leg configuration, employing cut strip laminations of silicon steel, in a butt lap or mitered pattern is contemplated. In a second example, a hexacore three-phase core with triangular core leg configuration, employing continuously wound loops of silicon steel may be utilized. In a third example, a distributed gap core, with three-phase linear core leg configuration, employing cut and formed strips of silicon steel, which are interleaved to provide staggered joints within the core legs is provided. In a fourth example, the transformer may include an amorphous core, with three-phase linear core leg configuration, employing cut and formed strips of amorphous steel. In a fifth example, the transformer may include a hexacore three-phase core with triangular core leg configuration, employing continuously wound loops of amorphous steel. Other configurations are intended to be within the scope of the present invention.

Although the present embodiment of the invention is disclosed as having three modules, it is within the scope of this invention that the transformer may have more or less than three modules. The transformer would function as disclosed above, wherein the number of modules would be determined based upon the load current and controlled by the controller. In addition, as previously mentioned, each module need not have the same output rating as all other modules or if they do, the set point need not be identical for each module. Thus, the present invention provides a novel modular, transformer Assembly which utilizes a controller to measure the output current required by a load connected to the transformer and connects and disconnects appropriate modules to match the output capability of the transformer to that required at any given moment by a connected load.

Modifications and substitutions by one of ordinary skill in the art are considered to be within the scope of the present invention, which is not to be limited except by the allowed claims and their legal equivalents.

The invention claimed is:

1. A three module transformer assembly, comprising:
a first transformer module with a first efficiency rating, said first transformer module having at least one input and at least one output, wherein said at least one input of said first transformer module is connected to an input;
a second transformer module with a second efficiency rating, wherein said second efficiency rating is lower than said first efficiency rating of said first transformer module, said second transformer module having at least one input and at least one output, wherein said at least one input of said second transformer module is connected to an input source by means of a control relay, said control relay responsive to a second transformer module control signal, for energizing and de-energizing said second transformer module;
a third transformer module with a third efficiency rating, wherein said third efficiency rating is equal to or lower than said second efficiency rating of said second transformer module, said third transformer module having at least one input and at least one output, wherein said at least one input of said third transformer module is connected to an input source by means of a control relay, said control relay responsive to a third transformer module control signal, for energizing and be energized and said third transformer module; and
a controller, coupled to said output of said first, second and third transformer modules and to said second and third transformer module control relay, and configured for sensing the output current of said transformer modules being drawn by a load coupled to said first, second and third transformer module outputs, for determining whether said output current of all of said transformer modules is equal to greater than one of said transformer modules or greater than two of said transformer modules, and responsive to said determination, for providing one or more of a second and third transformer module control signal for energizing one or more of said second and third transformer modules in response to said output current of said transformer modules being drawn by a load.

2. The transformer assembly structure of claim 1, wherein said controller is configured such that when said controller senses that said output current of said transformer modules being drawn by a load is less than a first pre-established percentage of said total output load capacity of said transformer assembly, said controller causes said transformer module control signal for said third transformer module to open, thereby deactivating said third transformer module.

3. The transformer assembly structure of claim 2, wherein said first pre-established percentage is ⅔ of said total output load capacity of said transformer assembly.

4. The transformer structure of claim 1, wherein said controller is configured such that when said controller senses that said output current of said transformer modules being drawn by a load is less than a second pre-established percentage of said total output load capacity of said transformer assembly, said controller causes said transformer module control signal for said second and third transformer modules to open, thereby deactivating said second and third transformer modules.

5. The transformer assembly structure of claim 2, wherein said pre-established percentage is ⅓ of a total output load capacity of said transformer assembly.

6. The transformer structure of claim 2, wherein said controller is configured such that when said controller senses that said output current of said transformer modules being drawn by a load is greater than said first pre-established percentage of said total output load capacity of said transformer assembly, said controller causes said transformer module control signal for said third transformer module to close, thereby activating said first, second and third transformer modules.

7. The transformer structure of claim 1, wherein said controller is configured such that when said controller senses that said output current of said transformer modules being drawn by a load is greater than said first pre-established percentage but less than said second pre-established percentage of said total output load capacity of said transformer assembly, said controller causes said transformer module control signal for only said second transformer module to close, thereby activating only said first and second transformer modules.

8. The transformer structure of claim 1, wherein said controller is configured to provide, on a predetermined basis irrespective to sensing the output current of said transformer modules being drawn by a load coupled to said first, second and third transformer module outputs, said second and third transformer module control signals, such that said controller rotates through the activation and deactivation of said second and third transformer modules thereby ensuring that all modules are periodically activated and deactivated.

9. The transformer structure of claim 1, wherein each transformer module of said transformer assembly includes a three-phase core with linear core leg configuration that employs cut strip laminations of silicon steel in a butt lap or mitered pattern.

10. The transformer structure of claim 1, wherein each transformer module of said transformer assembly includes a hexacore three-phase core with triangular core leg configuration that employs continuously wound loops of silicon steel.

11. The transformer structure of claim 1, wherein each transformer module of said transformer assembly includes a distributed gap core with three-phase linear core leg configuration that employs cut and formed strips of silicon steel that are interleaved to provide staggered joints within the core legs.

12. The transformer structure of claim 1, wherein each transformer module of said transformer assembly includes an amorphous core with three-phase linear core leg configuration that employs cut and formed strips of amorphous steel.

13. The transformer structure of claim 1, wherein each transformer module of said transformer assembly includes a hexacore three-phase core with triangular core leg configuration that employs continuously wound loops of amorphous steel.

14. A multi-module transformer assembly, comprising:
a plurality of transformer modules, each transformer module having at least one input and at least one output, wherein one of said plurality of transformer modules is continuously connected to an input source and to an output load, and wherein said at least one input of each of the remaining of said plurality of transformer modules is connected to said input source by means of a control relay, said control relay responsive to a predetermined transformer module control signal, each predetermined transformer module control signal configured for energizing and de-energizing a corresponding one of said plurality of transformer modules, wherein each of said plurality of transformer modules features an energy efficiency rating, at least one of said plurality of transformers including a first energy efficiency rating that is higher than a second energy efficiency rating of at least a second transformer; and
a controller, coupled to said output of each of said plurality of transformer modules, and configured for sensing the output current of said plurality of transformer modules being drawn by a load coupled to said plurality of transformer module outputs, for determining whether said output current of said plurality of transformer modules is equal to greater than one of said transformer modules or greater than two or more of said transformer modules, and responsive to said determination, for providing one or more of a transformer module control signal for energizing one or more of said plurality of transformer modules in response to said output current of said transformer modules being drawn by a load, wherein said controller energizes said transformer modules in the order of their energy efficiency rating from highest to lowest.

15. A multi-module transformer assembly, comprising:
a plurality of transformer modules, each transformer module having at least one input and at least one output, wherein one of said plurality of transformer modules is continuously connected to an input source and to an output load, and wherein said at least one input of each of the remaining ones of said plurality of transformer modules is connected to said input source by means of a control relay, said control relay responsive to a predetermined transformer module control signal, each predetermined transformer module control signal configured for energizing and de-energizing a corresponding one of said plurality of transformer modules, wherein each of said plurality of transformer modules features an energy efficiency rating, at least one of said plurality of transformers including a first energy efficiency rating that is higher than a second energy efficiency rating of at least a second transformer; and
a controller, coupled to said output of each of said plurality of transformer modules, and configured for sensing the output current of said plurality of transformer modules being drawn by a load coupled to said plurality of transformer module outputs, for determining whether said output current of said plurality of transformer modules is equal to greater than one of said transformer modules or greater than two or more of said transformer modules, and responsive to said determination, for providing one or more of a transformer module control signal for energizing one or more of said plurality of transformer modules in response to said output current of said transformer modules being drawn by a load, wherein said controller energizes said transformer modules in the order of their energy efficiency rating from highest to lowest and wherein said controller is further configured to provide, on a predetermined basis irrespective to sensing the output current of said transformer modules being drawn by a load coupled to said plurality of transformer module outputs, such that said controller rotates through the activation and deactivation of said plurality of transformer modules thereby ensuring that all transformer modules are periodically activated and deactivated
